(19) United States
(12) Patent Application Publication
(10) Pub. No.: US 2014/0372176 A1
(43) Pub. Date: Dec. 18, 2014

(54) METHOD AND APPARATUS FOR ANONYMOUS DATA PROFILING

(71) Applicant: Fusz Digital Ltd., Tortola (GB)

(72) Inventor: Eugene A. Fusz, Palm Beach, FL (US)

(21) Appl. No.: 14/473,268

(22) Filed: Aug. 29, 2014

Related U.S. Application Data
(63) Continuation of application No. 10/805,038, filed on Mar. 19, 2004, now abandoned.
Application No. 10/805,038 is a continuation-in-part of application No. 09/426,954, filed on Oct. 26, 1999, now abandoned.

(51) Int. Cl. G06Q 30/02

(52) U.S. Cl. CPC G06Q 30/0201; G06Q 30/0202; G06Q 30/0269
USPC 705/7.32

(57) ABSTRACT

A method for a consumer to provide himself with timely and appropriate marketing data while remaining anonymous to the sources of the marketing data is described. The method includes self-generating an anonymous consumer profile for the consumer, providing access to the anonymous consumer profile to one or more entities, and receiving marketing data from the entities based on the anonymous consumer profile. The method also includes providing feedback on the received marketing data, the feedback becoming a part of the anonymous consumer profile, and repeating the receiving marketing data and providing feedback steps.

### CROSS REFERENCE TO RELATED APPLICATIONS

This application is a Continuation-in-Part Application of U.S. application Ser. No. 09/426,954, filed Oct. 26, 1999, which is hereby incorporated by reference in its entirety.

### BACKGROUND OF THE INVENTION

This invention relates generally to methods for storing anonymous consumer profile data, and more particularly to methods and apparatus which allows consumers to generate anonymous, self-generated profiles which further allows the consumers to provide self-defined marketing data to marketers.

One well accepted marketing method is to gather information about a target audience and directs a product, or service, to that audience for review. However, it is difficult to obtain information about the target audience because many individuals do not freely provide information about themselves to strangers. One reason is because the more information people divulge about themselves, the more likely it is that others will use that information to contact the person that divulged the information.

Therefore, for a vendor to market a product or service, the vendor currently has to retain one or more of a marketing company and an advertising company to purchase targeting marketing and the media through which the targeted marketing will be applied. Such a marketing strategy is sometimes referred to as interruption marketing because the media forms likely used, are likely to interrupt the consumer in order to get their attention and include a “call to action” to be taken by the consumer. Such a strategy is inefficient because the timing for the marketing is likely inappropriate for a large segment of the targeted consumers. Such interruption marketing is likely to “put off” certain consumers due to the interruption and the ensuing “call to action”. One classic example is the television commercial. Many consumers are prone to switching channels when viewing televisions because they do not want their relaxation time interrupted. Other interruption marketing examples include radio commercials, pop up advertisements on internet connected computers, magazine and newspaper advertisements, and billboards.

### BRIEF DESCRIPTION OF THE INVENTION

In one aspect, a method for a consumer to obtain timely and appropriate marketing data while remaining anonymous to the sources of the marketing data is provided. The method comprises self-generating an anonymous consumer profile, personalized to the user, providing access to the anonymous consumer profile to one or more entities, receiving marketing data from the entities based on the anonymous consumer profile, providing feedback on the received marketing data, the feedback becoming a part of the anonymous consumer profile, and repeating the receiving marketing data and providing feedback steps.

In another aspect, a method for generating anonymous consumer profiles is provided. The method comprises providing a questionnaire of non-identifying, personal information to a consumer, receiving answers to the questionnaire, and configuring the received answers as a consumer profile. The method further comprises providing advertisements to the consumer based on the consumer profile, receiving feedback on the advertisements, and updating the consumer profile based on the feedback. The method also comprises repeating the steps of providing advertisements to the consumer, receiving feedback on the advertisements, and updating the consumer profile.

In another aspect, an anonymous consumer profiling system comprising at least one computer programmed as a web server and a database is provided. The system is configured to provide a questionnaire of non-identifying, personal information to a user, receive answers to the questionnaire from the user, configure the received answers as a consumer profile for the user, and provide advertisements to the user based on the consumer profile. The system is further configured to receive feedback on the advertisements from the user and update the consumer profile based on the received feedback. The computer is configured to maintain an anonymity of the consumer at all times.

In another aspect, an anonymous marketing method is provided. The method comprises encouraging a group of consumers to self-generate anonymous consumer profiles, marketing to the group of consumers based on the anonymous profiles, requesting feedback from the group of consumers regarding the marketing while maintaining their anonymity, adding the feedback to revise the anonymous profiles, and refining the marketing to the group of consumers based on the revised anonymous profiles.

### BRIEF DESCRIPTION OF THE DRAWINGS

FIG. 1 is a block diagram of an exemplary embodiment of a server architecture for a consumer generated anonymous data system;

FIG. 2 is a block diagram of an alternative exemplary embodiment of a server architecture for a consumer generated anonymous data system;

FIG. 3 is a schematic diagram of a method for generating anonymous data profiles of individuals; and

FIG. 4 is a schematic diagram of a method for utilizing anonymous data profiles to respond to marketing generated data sets.

### DETAILED DESCRIPTION OF THE INVENTION

Below described are methods and apparatus which provide consumers an ability to define personal marketing profiles by defining at least a timing and an appropriateness for potential received marketing. Such marketing empowers the consumers since for the most part the marketing profiles are self-generated. At least one result is a consumer centric marketing system which provides largely personalized marketing to consumers at a time and place of their choosing, with the relevancy of the marketing being determined by the consumers themselves. The marketing is based on demographics and professed desires with regard to products and services that might be offered as the consumers provide the information in their profiles that serve as the definitions that allow marketers to provide appropriate marketing data directly to them by filtering the profiles. In addition, the consumers are able to filter marketers, as in one embodiment, a marketer has to be “approved” by a consumer before that marketer has access to the anonymous profile. In addition, such methods and apparatus provide vendors with an ability to provide targeted marketing when desired by consumers while not requiring personal contact information for the consumer. It is believed to be desirable to provide consumers with timely marketing that they are interested in experiencing.

To accomplish the above, the methods and apparatus herein described protect anonymity of the users in multiple ways. First, users are not asked for identifying information. Also, the apparatus is configured such that identifying information will not be accepted. In one specific embodiment, identifying information is not accepted to ensure that the systems do not have access to such identifying information. Further, the methods and systems are such that identifying information is not utilized.

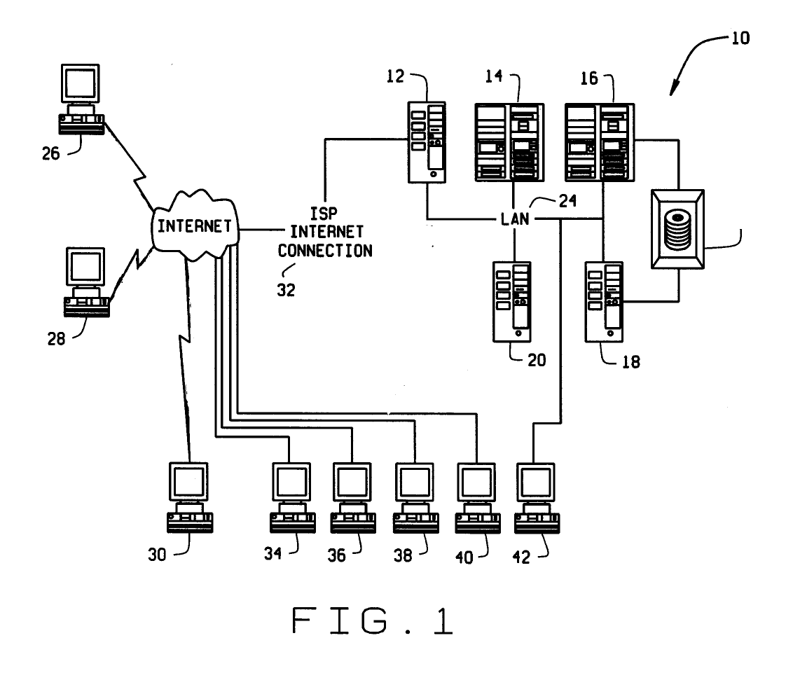

FIG. 1 is a block diagram of an exemplary embodiment of a server architecture for an electronic data communications network system 10 that gathers and utilizes consumer generated anonymous, personal data. System 10 is connected to a distributed computer network, such as the Internet, including that part of the Internet known as the World Wide Web. The term Web as used herein refers to the World Wide Web, wherein computers known as Web servers display graphical and textual information using files or “pages” composed in Hyper Text Mark-up Language (HTML). The Web servers communicate information over the Web or other network from a Web server at a central site to a remote computer terminal used by a customer. Although the exemplary system described herein is implemented on the Web, it should be understood that other types of distributed computer networks are suitable for being connected to system 10.

In one embodiment of system 10, the location of a page on the Web is specified by a uniform resource locator (URL), which is an alphanumeric string representing the server address on the Web. At the remote computer terminal, a remote user initially accesses a page by typing a specified URL into a Web-browser such as Netscape™ by Netscape Communications Corporation, or Internet Explorer™ by Microsoft Corporation. Multiple pages at a Web site are linked together via hyperlinks which are represented on a computer screen by a graphical icon such as a button or a highlighted line of text. Hyperlinks are configured to implicitly invoke another URL when a computer user clicks on a computer mouse button while a mouse-controlled screen cursor is positioned over a hyperlink icon.

In one embodiment, as shown in FIG. 1, system 10 includes a web server 12, an application server 14, a database server 16, a directory server 18, and a workflow server 20. A disk storage unit 25 is coupled to database server 16 and directory server 18 and provides a data repository for storing data pertaining to consumer generated anonymous data and marketer generated data. Servers 12, 14, 16, 18, and 20 are coupled in a local area network (LAN) 24. LAN 24 also includes a processor (not shown) programmed to communicate with servers 12, 14, 16, 18, and 20.

Web server 12 is configured to be communicatively coupled to computers 26, 28, and 30 of marketers, via an ISP Internet connection 32, for example, a wireless connection. In addition, a plurality of computers 34, 36, 38, and 40 of individual consumers are communicatively coupled to web server 12 via ISP Internet connection 32. Such connections may also be wireless. Further, at least one work station 42 is coupled to LAN 24 for simultaneous monitoring of various tasks and methods by an intermediary as described below. The processor is further programmed to communicate with marketer computers 26, 28, and 30, with consumer computers 34, 36, 38, and 40, and with work station 42.

The communication in the exemplary embodiment is illustrated as being performed via the Internet through web browsers loaded onto computers 26, 28, 30, 34, 36, 38, and 40 of consumers and marketers, respectively. Other wide area networks (WAN), however, could be used in other embodiments, i.e., the systems and processes described herein are not limited to being practiced over the Internet. LAN 24 is configured to store data obtained through an interface (not shown) such as a web page maintained on web server 12, to compare data generated by consumers with data generated by marketers, and to enable consumers to access selected sets of information generated by marketers.

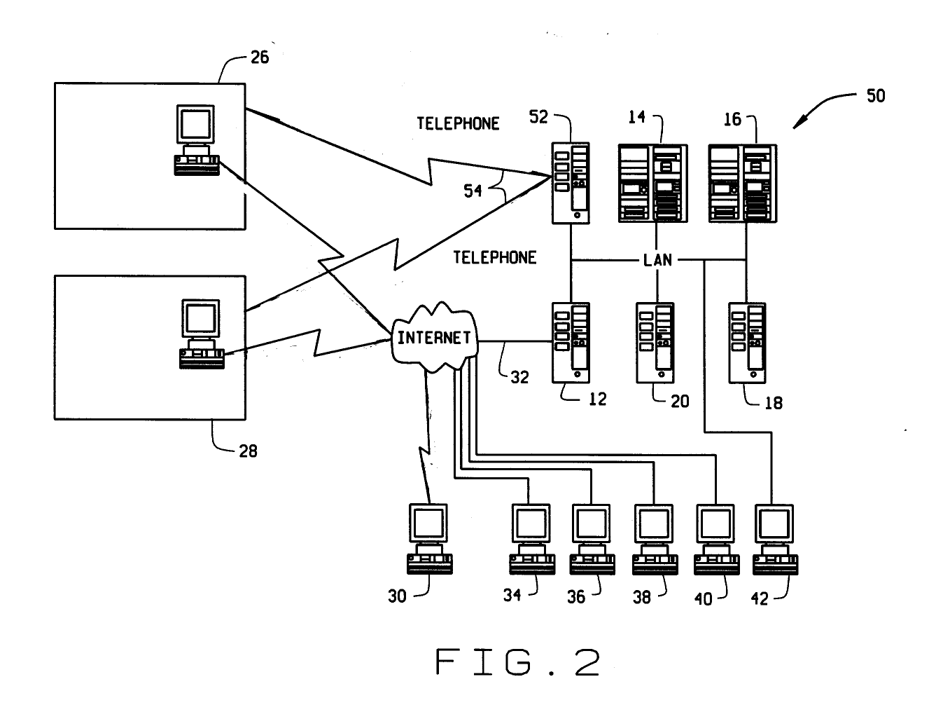

FIG. 2 is a block diagram of another server architecture for a system 50 that gathers and utilizes consumer generated anonymous data. Components in system 50 identical to components of system 10 are identified in FIG. 2 using the same reference characters as in FIG. 1. System 50 further includes a fax server 52 coupled to LAN 24. Fax server 52 communicates with marketers via a telephone link 54.

The architecture of systems 10 and 50 are exemplary only. Other architectures are possible and can be utilized in connection with practicing the methods described below. Moreover, the methods described below, in one embodiment, are initiated by a consumer without a computer or fax machine. For example, customers phone or mail the required information and an operator enters data directly into LAN 24 by workstation 42 or by an operator with a computer remotely communicating with LAN 24 through ISP Internet Connection 32 or other WAN.

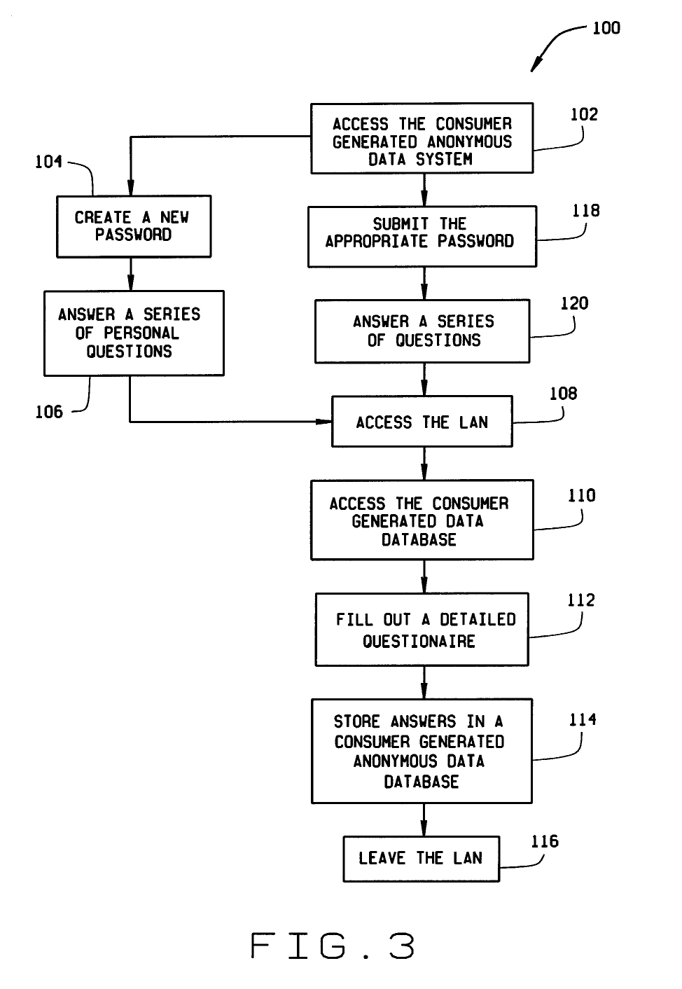

FIG. 3 is a schematic diagram of a method 100 for generating anonymous, personal data profiles about a consumer. Method 100 includes the step of accessing 102 an anonymous data system which includes, at least in part, consumer self-generated anonymous profiles. Examples of such a system are systems 10 and 50 shown in FIGS. 1 and 2, respectively. As described below in greater detail, the information supplied by the individuals is considered to be confidential and personal information. To protect the information from unauthorized individuals seeking access, the system includes a security element. One example of such a security element is a firewall.

The firewall is a software-based gateway which impedes or limits access to a LAN, such as LAN 24 shown in FIGS. 1 and 2. The access is machine-limited so that only authorized remote computers have permission to get through the firewall. To implement the firewall, the system in one embodiment includes servers, such as web server 12 shown in FIGS. 1 and 2, mail server 22 shown in FIG. 1, or fax server 52 shown in FIG. 2, through which all communications with computers outside LAN 24 must take place. Servers 12, 22, and 52 are programmed to validate queries from a user on any machine authorized to communicate with LAN 24 via remote terminals, such as terminals 26, 28, 30, 34, 36, 38, 40, and 42. Servers 12, 22, and 52 include special programs enabling them to forward valid requests or queries from authorized machines through the firewall to LAN 24.

Alternatively, the security element identifies authorized users rather than machines. This approach is more complex than the basic firewall approach because queries or requests from a user on any remote terminal are validated using an encrypted unique identifier inputted at the remote terminal The unique identifier is, for example, a password such as a validation code consisting of an alphanumeric string. Alternatively, the password is combined with answers to a series of questions. The unique identifier is encrypted to frustrate password sniffers capable of intercepting unencrypted passwords as they pass from machine to machine through the Web. Servers 12, 22, and 52 validate the encrypted unique identifier, and allow access to LAN 24. In another alternative embodiment, the security element identifies authorized users using a one-time or limited use password supplied by servers 12, 22, and 52 on request from the user.

In one embodiment, to protect anonymity of a user, the user accesses systems 10 and/or 50 through a website from a computer which is running an anonymizing software program or subscribed to an anonymizing service provided by the administrators of systems 10 and 50 or a third party. In addition, systems 10 and 50 do not retain the IP addresses provided to it. Such programs allow for anonymous web surfing and private web browsing and act as a shield to prevent tracking of web browsing habits and personal information. At least one known anonymizing program encrypts and reroutes connection requests through proxy servers with 128-bit encryption so that the described web sites that are accessed by hackers will not result in the hacker retrieving any identifying personal information. One example of such a program and service is WebSecure, which is a trademark of Zero-Knowledge Systems Inc.

In an exemplary embodiment, when a user initially accesses the consumer generated anonymous data system, the user is requested to create 104 a multi-character password that is non-identifying and possibly randomly generated. After an appropriate non-identifying password has been created, the user is then requested 106 to answer a series of questions. Alternatively, the user chooses a series of questions and answers those questions accordingly. The questions are personal questions that, though non-identifying, invoke answers specific to the user. Some exemplary questions are age range, number of siblings, automobile type, and next new car type. Answers to such personal questions are stored to provide extra security and continued anonymity if, for example, a hacker determines a user's password. Additionally, answers to personal questions provide a means for users that have lost their password to gain access to the anonymous data system. In such an embodiment, a sufficient number of questions have been previously answered so that system 10 can determine whether the answers are coming from a registered user and identify the profile for that user. In other words, questions and answers are sorted to provide unique combinations for each stored profile.

After the personal questions have been answered, the user is granted access 108 to LAN 24. Once LAN 24 has been accessed, the user is provided access 110 to certain databases within the anonymous data system where they may enter non-identifying, relevant, consumer data as at least part of a consumer profile. For example, and in one embodiment, a user is requested to complete 112 a detailed questionnaire as described below in greater detail. The answers to the questions in the questionnaire are stored 114 in a consumer generated anonymous database and are further configured as a consumer profile for that user. When the user decides to leave 116 the database (e.g., decides to answer no further questions from the questionnaire) and the LAN, the user logs out of the consumer generated anonymous data system.

When the user decides to return to the consumer generated anonymous data system, the user again accesses 102 the consumer generated anonymous data system and is requested by the system to submit 118 the user's username and/or password. In one embodiment, the system is accessed via a web page. Examples of usernames and/or passwords could be randomly generated, the number of the user's home address, or the last two or three digits of their zip code, neither of which would compromise anonymity. If the correct password is submitted, the user is then requested 120 to answer one or more of the personal questions specific to the user identified by the password as described above. Each question is asked only one time, or a limited number of times, per visit, or per day, to reduce the possibility of someone other than the user correctly answering the questions. In addition, all communications between the user and the consumer generated anonymous data system are encrypted to provide additional security measures for method 100.

If the user answers the question or questions correctly, the user is granted access to the LAN as described above. If the user answers the question or questions incorrectly, the user is requested to answer an additional question. If the user answers the additional question correctly, the user is granted access to the LAN. If, however, the user answers the additional question incorrectly, the user is requested to answer a further question. This question and answer session continues until either the user correctly answers a question, or the system exhausts its list of questions. If no correct answers are given, the user is denied access to the system. In an alternative embodiment, if the user incorrectly answers the first question, the user is denied access to the system for a specified period of time such as the remainder of the day.

When access is granted to the user, all communications between the user and the consumer generated anonymous data system are conducted utilizing the password. Before presenting the user with questions from the questionnaire, the user is directed to supply no contact information to the system. Further, the system is configured that it cannot accept such contact information. Such contact information includes, but is not limited to, name, address, social security number, and telephone number and is sometimes referred to as identifying information. The lack of identifying information in the consumer generated anonymous data database adds a further layer of privacy to the information supplied by the user to the system. The user supplied information is then utilized by the system, while the user's identifying information is maintained in confidence by the user. The system never has access to the user's identifying information.

One method contemplated for ensuring that identifying information or contact information is not provided to systems 10 and 50 is accomplished through the formatting of the questionnaires utilized to collect the information. For example, users that are logged into systems 10 and 50 are presented with multiple choice answers to the questions asked upon a successful login. Specifically, personal information utilized to build the profiles is received from the users through one or more of true/false selections, pull-down messages/menus, and multiple choice selections. Therefore, text entry of data is not allowed in the described embodiment, further ensuring that identifying information cannot be entered by a user, and further ensuring that the profiles remain anonymous. Further, should either of systems 10 and 50 be compromised by a hacker, no contact information could be accessed as there is no link to any contact information. In other embodiments, text entry is allowed for certain questions of the questionnaire where a user is not likely to enter personally identifiable information, for example, in response to a question regarding a favorite color.

It is known that computers that are networked together, for example, utilizing the Internet, transmit and receive data regarding the source of the data. For example, a computer that is connected to the Internet may be assigned an internet protocol (IP) address. To further protect the anonymity of the users, systems 10 and 50 may be configured to encrypt and decrypt transmissions between the various computers. In addition, systems 10 and 50 are configured to instruct user computers to not store responses to questions from the questionnaires. Further, and in one embodiment, web pages accessed by the users answering questionnaire are dynamically generated and previously accessed pages are not cached. Therefore any possibility that an unauthorized user could find consumer profile data information within a user's computer is effectively eliminated.

As described above, the consumer profiles are generated based on the answers given to the questionnaires. A series of questionnaires will be presented to the consumer. In one embodiment, each questionnaire will take the consumer about 10-15 minutes to complete. The questions will be formatted, for example, as multiple choice, true/false, or short answers that are not text entry based, for example, pull down menus. The first questionnaire will be general in nature, and will include questions directed, for example, to categories such as age, sex, marital status, zip code, number, sex, and ages of children, spouse, job, residence, pets, hobbies, cars, and others. While many of these questions are very personal in nature, they do not uniquely identify an individual. Therefore it is thought that a user will more likely provide truthful answers to such questions. Follow-up questionnaires will include questions directed towards answers given in the initial, or previous, questionnaires. In one embodiment, consumers are provide compensation in return for creating and updating their consumer profiles utilizing the same methods as described with respect to compensation for consumer feedback.

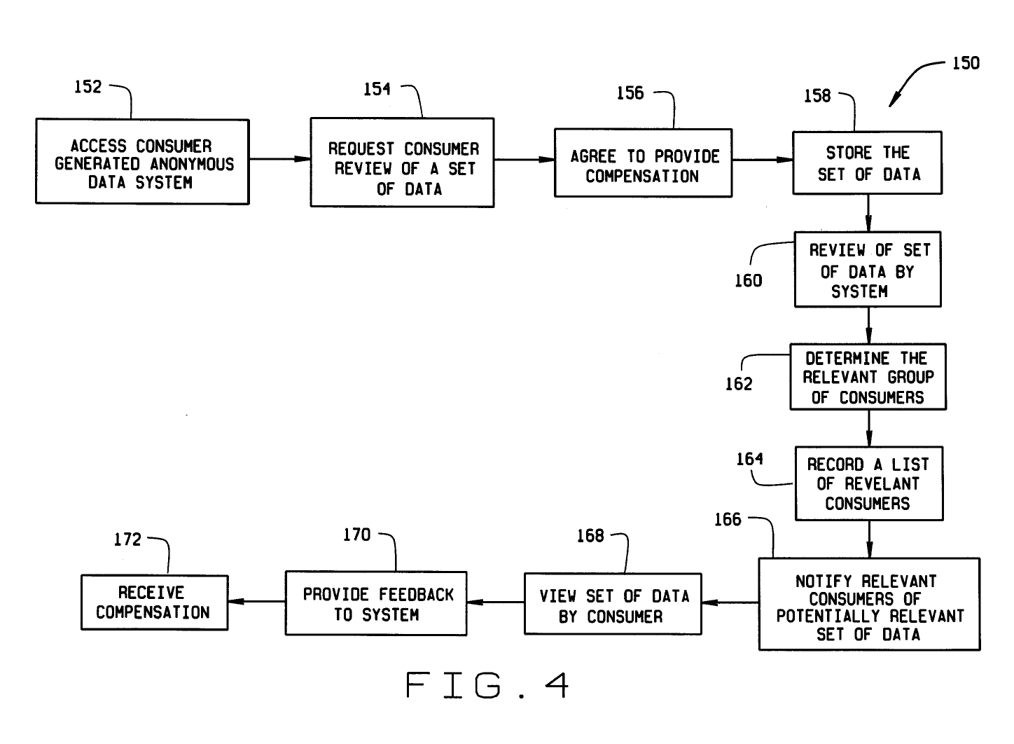

FIG. 4 is a schematic diagram of a method 150 for providing feedback regarding sets of marketing data utilizing anonymous consumer profiles. The anonymous consumer generated profiles are generated and stored as explained above with respect to FIG. 3. After the profiles are generated, a consumer generated anonymous data system, such as one of systems 10 and 50 shown in FIGS. 1 and 2, respectively, accepts marketer generated data, i.e., advertising data, in a marketer data base, as described below. An administrator, or intermediary, oversees the consumer generated anonymous data system and is the point of contact for the marketers and for the consumers. Thus, the marketers have no direct contact with the consumers.

An entity (i.e., a vendor or a marketing company) that desires to have consumer feedback on one or more products or services accesses 152 the consumer generated anonymous data system via a URL. The marketing company then requests 154 to have a set of data reviewed by a relevant group of consumers. The sets of data may be, for example, an advertisement or other information on which the entity would like to obtain feedback. The advertisements are then directed to the individual consumers based on their consumer profiles.

In one example, where a group of consumers has answered 50 questions, the entity may select a group of users based on answers (or a group of answers) to five of the 50 questions. Allowing such selection of delimiters by the entity allows them to market to who they want to do business with, and also to control the number of profiles to whom they market. Such control is important. For example, if the marketing includes payments for feedback, an entity will want to know what their total costs for marketing could be, for example, for budgetary planning purposes.

For example, one piece of information (e.g., questionnaire answer) a marketer might want with regard to a group of consumers is when they most recently purchased an automobile. Based on the consumer profiles within the consumer generated anonymous data system, a marketer might choose to only send their advertisements to those consumer profiles where more than two years has passed since a vehicle purchase. The consumer may also select the types of marketing they wish to receive, for example, based on prior and anticipated purchases, in one embodiment, based on answers provided to questionnaire questions, which results in further questions being asked, and ultimately answered. The process provides a focus to the products and service marketed to the consumer.

In one embodiment, the company agrees 156 to provide compensation in return for feedback from the relevant group of consumers. The compensation is paid to the intermediary, who then distributes a portion of the compensation to the consumers, as described below in greater detail. The set of data is then stored 158 in a marketer database. The feedback is reviewed 160 by the system to determine 162 the relevant group of consumers. For example, the consumer generated anonymous data system includes a processor programmed to compare the set of data with each consumer generated profile. The processor determines which individual consumer profiles may belong to consumers interested in viewing the set of data, for example, the profiles where the most recent automobile purchase was two or more years ago.

After the processor has determined which consumers may be interested in viewing the set of data, a record is made 164 of those consumer profiles. When each consumer accesses the consumer generated anonymous data system, those consumers are notified 166 of a potentially relevant set of data that may be of interest to them. In another embodiment, rather than notifying the consumers, the marketing data is made available for viewing by relevant consumers according to their choosing. If the consumer views 168 the set of data, the consumer is given the opportunity to provide 170 feedback to the system with respect to that set of data. The feedback provided by the consumer will include information regarding whether the consumer approved or disapproved of the set of data. In addition, the feedback will include information regarding whether the consumer has any interest in viewing similar sets of data in the future, and whether the timing for viewing similar sets of data is appropriate. The system will thus be able to better match consumers with sets of data based on the feedback provided by the consumers. The feedback that is directed towards the approval or disapproval of the set of data will be aggregated by the intermediary and then provided to the company. In addition, the feedback will be broken down in a detailed format. In one embodiment, the potentially relevant set of data (e.g., an advertisement) which the consumer will review and possibly provide feedback is sent via an anonymous E-mail inbox, in one embodiment, located within the same location as the anonymous consumer profile, which may provide one or more of a description of the advertisement, in text, video, and/or audio, an amount of payment for review of the advertisement and an amount of rebate available for the purchase of the products and services being advertised. Alternatively, the consumers may be provided with links to an E-mail inbox, allowing the consumer to better decide which advertisements they wish to review and comment upon.

The feedback is utilized, in one embodiment, to update the consumer profile for the consumer that answered the questionnaire. The process is continuing, so that each time a consumer answers a questionnaire their profile is further updated with additional relevant, non-identifying information for that consumer. As the system receives more and more feedback from the consumer, it further refines the marketing presented to each consumer based on the continuously updated consumer profiles. Follow on questionnaires provided to the consumer are more and more relevant to the information contained in their consumer profile. A benefit to the consumer is that they are better able to control an amount, a relevancy, and a type of the marketing provided to them. A benefit to the marketer is that as the profiles become more detailed, the marketing provided to the consumers has a higher likelihood of ending in a successful sale.

Therefore, the marketer is able to appropriately target and time their marketing efforts based on the best available data, including, but not limited to, prior purchases and needs or wants that have become part of the profiles. In addition, the system allows a user to access and revise the answers to previously asked questions. Utilizing the sample above, the user may choose to make the system aware that he or she has recently purchased an automobile, and therefore the previously given answer of more than two years since the last automobile purchase is now incorrect and has been updated. Of course, a marketing concern for automobiles wants this type of information, as they can change their marketing for this particular consumer, even though the consumer's identity is unknown.

In one embodiment, the consumer then receives 172 compensation for providing feedback with respect to the set of data. In an exemplary embodiment, the compensation is in the form of digital cash certificates, rebates, or a discount coupon issued to the user. The digital cash certificates can be taken to a designated bank, savings and loan, or credit union for redemption. The rebate forms and discount coupons, which may include a bar code or the like, can be printed by the user and taken to the vendor for utilization in the contemplated purchase where the bar code is used in verification. The consumer profile thus maintains anonymity and the consumer behind the anonymous profile is still able to be compensated for their time in providing feedback regarding the sets of marketing data reviewed. In an alternative embodiment, the consumer may be given access to a randomly generated web site address, where they may obtain the digital cash, online credits, or the coupon.

Although the marketing company can access the consumer generated anonymous data system, the company is unable to access the consumer generated anonymous data located in the database. Access to the information within the consumer generated anonymous database is only permitted to those that enter a correct password and answer correctly a series of questions. Therefore, the company does not have access to any of the consumer generated anonymous data other than that provided by the intermediary regarding the aggregated information of the consumers.

The LAN and the consumer generated anonymous data system are operated by an intermediary that causes systems 10 and 50 to sort and organize the profile data (e.g., questionnaire answers) entered by the consumers and to match that data to the desired market targets provided by vendors. That is, systems 10 and 50 match the correct set of marketing data to be reviewed with the consumer profiles for review of the data. Systems 10 and 50 also forward the appropriate compensation to the appropriate individual profile after review of an amount of marketing materials. The intermediary may configure systems 10 and 50 to automatically review marketing message content to ensure offensive marketing is not forwarded to consumer profiles. In another embodiment, the intermediary performs this function manually.

It is believed that most computer systems have been compromised at one time or another by unauthorized users (e.g., hackers). While there have been some marketing systems and databases that claim to be anonymous, these systems still require a user to enter personal contact information (e.g., name address, SSN, etc.) to register as an authorized user. Therefore, when such a system is accessed by an unauthorized user (e.g., a hacker), the personal contact information for system users is at risk. The above described systems and methods, which are configured with an inability to accept such personal contact information, are believed to alleviate such concerns by users as they can freely divulge very personal, yet not identifying information. Should a hacker access such a system, the captured data is no reward as the data included therein includes only the questions and answers related to the profiles, which is non-identifying, and therefore discouraging and providing at least a partial solution to identity theft.

The consumer generated anonymous data system and the method for generating anonymous data profiles provides a level of security to individual consumers. The consumers can freely divulge information without anyone knowing who provided the information. The system allows the consumer to create a self-generated profiling data set that is rich in content, yet anonymous. The reward for consumers for generating such highly detailed consumer profiles is that they are provided with highly relevant marketing data which they have essentially requested. Another reward is the possibility of larger rebates and discounts than in known programs because the marketing has a higher probability of success due to the focused audience. Because of the rich content of the data set (consumer profiles), the system provides efficient, privacy sensitive, targeted, consumer centric marketing to consumers from companies and other entities which respects the consumers time and the giving of their attention. In return, companies are rewarded with a higher likelihood of marketing success and aggregated feedback from a targeted audience of anonymous consumers which can provide insight into products and services.

The above described methods and apparatus are also advantageous to vendors. Rather than contracting with marketing companies and media to market their products and/or services, the vendors can utilize their resources to ensure that their products and/or services are being experienced by a relevant set of consumers by providing compensation of some type to the relevant consumers. It is believed that such an approach can lower marketing costs for vendors as they only pay for consumer feedback and a fee to operators of systems 10 and 50 (e.g., intermedary) rather than entering into contracts with marketing and advertising companies.

Vendor participation in such a marketing system is important. It is conceivable that vendors that participate in such a consumer centric marketing methodology are favorable to do business with as opposed to competing vendors that utilize interruption marketing. Such competing vendors may be held in an unfavorable light as they could be perceived as and not caring about the timing needs of possible customers. Whereas in utilizing the methods described above, the marketing occurs at a time and place of the consumers choosing, creating the perception that the vendor values the consumers timing needs.

While the invention has been described in terms of various specific embodiments, those skilled in the art will recognize that the invention can be practiced with modification within the spirit and scope of the claims.

1-38. (canceled)

39. A method for generating a database of personalized anonymous consumer profiles, said method comprising:
providing a questionnaire to a consumer, the questionnaire accessible utilizing a consumer computer communicatively coupled to a server computer that includes a database for storing the questionnaire, the questionnaire including only questions having a nature such that answers to the questions include only non-identifying information concerning the consumer;
accepting answers to the questionnaire at the server computer from the consumer computer, the answers entered via a user interface displayed by the consumer computer, the user interface configured such that only answers containing non-identifying information may be entered into the user interface;
configuring the received answers as a consumer profile of one or more files stored within one or more consumer profile databases, stored in the server computer database, all of the stored files and the one or more consumer profile databases including only non-identifying information concerning the consumer;
providing at least one advertisement to the consumer, via the computer user interface, based on data within the consumer profile database;
receiving, by the server computer, anonymous feedback on the at least one advertisement;
providing, by the server computer, the anonymous feedback to at least one marketer computer such that the consumer is not identified to the at least one marketer computer; and
updating the consumer profile database based on the received feedback.

40. The method of claim 39, wherein providing the at least one advertisement to the consumer further comprises providing the at least one advertisement to a plurality of consumers, and providing the anonymous feedback to at least one marketer computer further comprises aggregating the anonymous feedback.

41. The method of claim 39, wherein providing the at least one advertisement further comprises transmitting, by the server computer, the at least one advertisement to an anonymous e-mail inbox.

42. The method of claim 39, wherein providing the at least one advertisement further comprises transmitting, by the server computer, at least one link to an e-mail inbox that includes the at least one advertisement.

43. The method of claim 39, wherein providing the at least one advertisement further comprises transmitting, by the server computer, one or more of a description of the at least one advertisement, an amount of payment for review of the at least one advertisement, and an amount of rebate available for purchase of one or more products or services being advertised.

44. The method of claim 39, wherein receiving anonymous feedback includes receiving an indication of at least one of approval of the at least one advertisement and disapproval of the at least one advertisement.

45. The method of claim 39, wherein accepting answers to the questionnaire further comprises:
receiving, by the server computer, at least one initial answer to the questionnaire at a first time;
receiving, by the server computer, at least one updated answer to the questionnaire at a second time that is after the first time; and
replacing, by the server computer, the initial answer with the updated answer.

46. The method of claim 39, further comprising:
generating, by the server computer, an anonymous account for the consumer; and
transmitting, by the server computer, compensation to the anonymous account after receiving the anonymous feedback.

47. The method of claim 46, further comprising transmitting at least one of a digital cash certificate, a rebate, and a discount coupon to the anonymous account.

48. The method of claim 46, further comprising transmitting a randomly generated address of web site to the anonymous account, wherein the web site provides at least one of digital cash, online credits, and a coupon.

49. An anonymous consumer profiling system comprising a server computer that includes one or more processors and is coupled to a memory, said server computer is configured to:
provide a questionnaire to a consumer, the questionnaire accessible utilizing a consumer computer communicatively coupled to said server computer, the questionnaire including only questions having a nature such that answers to the questions include only non-identifying information concerning the consumer;
accept answers to the questionnaire from the consumer computer, the answers entered via a user interface displayed by the consumer computer, the user interface configured such that only answers containing non-identifying information may be entered into the user interface;
configure the received answers as a consumer profile within the memory, the consumer profile including only non-identifying information concerning the consumer;
provide at least one advertisement to the consumer, via the computer user interface, based on data within the consumer profile;
receive anonymous feedback on the at least one advertisement;
provide the anonymous feedback to at least one marketer computer such that the consumer is not identified to the at least one marketer computer; and
update the consumer profile based on the received feedback.

50. The system of claim 49, wherein said server computer is further configured to:
provide the at least one advertisement to a plurality of consumers; and
aggregate the anonymous feedback.

51. The system of claim 49, wherein said server computer is further configured to provide the at least one advertisement by transmitting the at least one advertisement to an anonymous e-mail inbox.

52. The system of claim 49, wherein said server computer is further configured to provide the at least one advertisement by transmitting at least one link to an e-mail inbox that includes the at least one advertisement.

53. The system of claim 49, wherein said server computer is further configured to transmit one or more of a description of the at least one advertisement, an amount of payment for review of the at least one advertisement, and an amount of rebate available for purchase of one or more products or services being advertised.

54. The system of claim 49, wherein said server computer is further configured to receive an indication of at least one of approval of the at least one advertisement and disapproval of the at least one advertisement.

55. The system of claim 49, wherein said server computer is further configured to:
receive at least one initial answer to the questionnaire at a first time;
receive at least one updated answer to the questionnaire at a second time that is after the first time; and
replace the initial answer with the updated answer in the memory.

56. The system of claim 49, wherein said server computer is further configured to:
generate an anonymous account for the consumer; and
transmit compensation to the anonymous account after receiving the anonymous feedback.

57. The system of claim 56, wherein said server computer is further configured to transmit at least one of a digital cash certificate, a rebate, and a discount coupon to the anonymous account.

58. The system of claim 56, wherein said server computer is further configured to transmit a randomly generated address of web site to the anonymous account, wherein the web site provides at least one of digital cash, online credits, and a coupon.
